(19) United States
(12) Patent Application Publication
(10) Pub. No.: US 2026/0188864 A1
(43) Pub. Date: Jul. 2, 2026

(54) SECONDARY BATTERY

(71) Applicant: SAMSUNG SDI CO., LTD., Yongin-si (KR)

(72) Inventor: Kiyoun JEON, Yongin-si (KR)

(21) Appl. No.: 19/422,721

(22) Filed: Dec. 17, 2025

(30) Foreign Application Priority Data
Dec. 31, 2024 (KR) 10-2024-0202873

(51) Int. Cl. H01M 50/533; H01M 50/119; H01M 50/176; H01M 50/186; H01M 50/557

(52) U.S. Cl. CPC H01M 50/533; H01M 50/119; H01M 50/176; H01M 50/186; H01M 50/557

(57) ABSTRACT

A secondary battery includes a can and an electrode assembly accommodated in the can. The electrode assembly includes a first electrode, a second electrode, and a separator disposed between the first electrode and the second electrode. A first electrode tab is connected to the first electrode, and a second electrode tab is connected to the second electrode. The electrode assembly includes a first horizontal portion and a second horizontal portion at an end of the electrode assembly, with a step being formed between the first horizontal portion and the second horizontal portion.

### CROSS-REFERENCE TO RELATED APPLICATION

The present application claims priority to and the benefit of Korean Application No. 10-2024-0202873, filed on Dec. 31, 2024, in the Korean Intellectual Property Office, the entire disclosure of which is incorporated by reference herein.

### BACKGROUND

### Technical Field

The present disclosure relates to a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Energy density of a secondary battery is the amount of energy that can be stored per unit volume. Energy density is one of the important factors determining performance of a secondary battery because a secondary battery having a high energy density may provide, for example, a longer operating time of a portable device or a longer driving range in an electric vehicle. Accordingly, various technologies to increase energy density have been developed, such as improving the structure of a case of the secondary battery.

The above information disclosed in this Background section is for enhancement of understanding of the background of the present disclosure, and therefore, it may contain information that does not constitute related (or prior) art.

### SUMMARY

An object of the present disclosure is to provide a secondary battery that has improved energy density by using the inner space of a can of the secondary battery.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

In some embodiments, a secondary battery includes a can and an electrode assembly accommodated in the can, with the electrode assembly including a first electrode, a second electrode, and a separator disposed between the first electrode and the second electrode, a first electrode tab connected to the first electrode, and a second electrode tab connected to the second electrode. The electrode assembly includes a first horizontal portion and a second horizontal portion at an end portion of the electrode assembly, with a step difference formed between the first horizontal portion and the second horizontal portion.

In some embodiments, the second horizontal portion may protrude beyond the first horizontal portion in a direction perpendicular to an upper surface of the first horizontal portion.

In some embodiments, a part of the first electrode tab may be disposed on the first horizontal portion, and a part of the second electrode tab may be disposed on the second horizontal portion.

In some embodiments, the secondary battery may further include an electrode terminal disposed on a surface of the can, wherein the first electrode tab may be connected to the electrode terminal, and the second electrode tab may be connected to the can.

In some embodiments, the first electrode tab may be bent in a space between the first horizontal portion and the first electrode terminal, and the second electrode tab may be bent in a space between the second horizontal portion and the can.

In some embodiments, the first electrode terminal may include a terminal portion extending through a hole formed in the can, a gasket inserted into the hole to insulate between the terminal portion and the can, a terminal plate connected to the terminal portion inside the can, and an insulating plate disposed between the can and the terminal plate to insulate between the terminal plate and the can.

In some embodiments, the first electrode tab may be connected to the terminal plate.

In some embodiments, the second horizontal portion does not contact the terminal plate.

In some embodiments, a length of the second horizontal portion in a direction parallel to an upper surface of the second horizontal portion may be greater than a length of the first horizontal portion in a direction parallel to the upper surface of the first horizontal portion.

In some embodiments, the can may include a metallic material, and the metallic material may include at least one of aluminum, aluminum alloy, and stainless steel.

In some embodiments, the first electrode tab may be longer than the second electrode tab.

In some embodiments, a secondary battery includes a can and an electrode assembly accommodated in the can, with the electrode assembly including a first electrode, a second electrode, and a separator disposed between the first electrode and the second electrode, a first electrode tab connected to the first electrode, and a second electrode tab connected to the second electrode. The electrode assembly includes a first horizontal portion, a second horizontal portion and a third horizontal portion at an end of the electrode assembly, with a first step formed between the first horizontal portion and the second horizontal portion, and with a second step formed between the second horizontal portion and the third horizontal portion.

In some embodiments, the second horizontal portion may be formed between the first horizontal portion and the third horizontal portion.

In some embodiments, the second horizontal portion may protrude beyond the first horizontal portion in a direction perpendicular to an upper surface of the first horizontal portion, and the third horizontal portion may protrude beyond the second horizontal portion in a direction perpendicular to the upper surface of the first horizontal portion.

In some embodiments, a part of the first electrode tab may be disposed on the first horizontal portion, and a part of the second electrode tab may be disposed on the third horizontal portion.

In some embodiments, the secondary battery may further include an electrode terminal disposed on a surface of the can, wherein the first electrode tab may be connected to the electrode terminal, and the second electrode tab may be connected to the can.

In some embodiments, the first electrode terminal may include a terminal portion extending through a hole formed in the can, a gasket inserted into the hole and to insulate between the terminal portion and the can, a terminal plate connected to the terminal portion inside the can, and an insulating plate disposed between the can and the terminal plate to insulate between the terminal plate and the can.

In some embodiments, the first electrode tab may be connected to the terminal plate.

In some embodiments, the second horizontal portion and the third horizontal portion do not contact the terminal plate.

In some embodiments, the first electrode tab may be longer than the second electrode tab.

According to embodiments of the present disclosure, by forming the electrode assembly so that one end thereof has a step, it is possible to additionally dispose the electrode assembly in a remaining inner space of the can of the secondary battery. Accordingly, a secondary battery with improved energy density may be provided.

According to some embodiments of the present disclosure, by using a can formed of a metal as the exterior material of the secondary battery, it is possible to facilitate detaching the secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of a secondary battery according to embodiments of the present disclosure.

FIG. 2 is a cross-sectional view of a secondary battery according to embodiments of the present disclosure.

FIG. 3 is an enlarged view of region A of FIG. 2.

FIG. 4 is a cross-sectional view of the secondary battery of FIG. 2, as viewed from direction B.

FIG. 5 is a cross-sectional view of the secondary battery of FIG. 2, as viewed from direction C.

FIG. 6 is a cross-sectional view of a secondary battery according to embodiments of the present disclosure.

FIG. 7 is a cross-sectional view of a secondary battery according to embodiments of the present disclosure.

FIG. 8 is a method of manufacturing an electrode assembly according to embodiments of the present disclosure.

FIG. 9 is a diagram of an electrode assembly assembled by the manufacturing method of FIG. 8.

FIG. 10 is a flowchart of a method of manufacturing a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

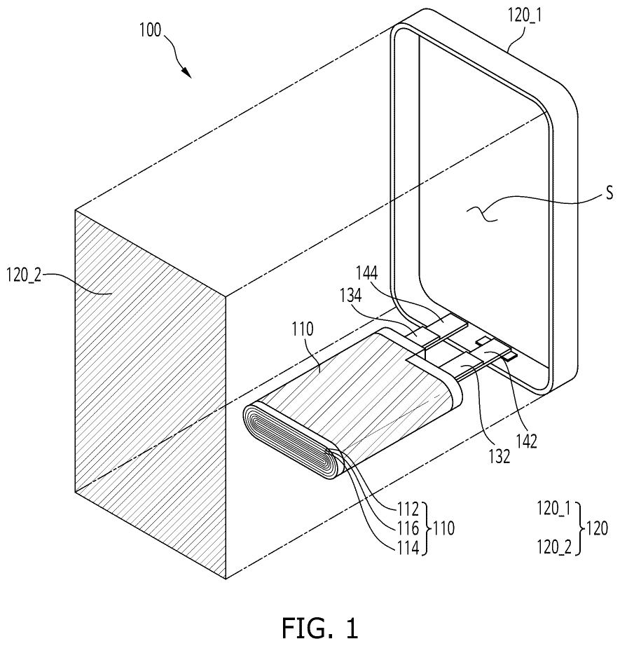

FIG. 1 is an exploded perspective view of a secondary battery 100 according to embodiments of the present disclosure. Referring to FIG. 1, the secondary battery 100 may include an electrode assembly 110 comprising a first electrode 112, a second electrode 114, and a separator 116 disposed between the first electrode 112 and the second electrode 114. The electrode assembly 110 is accommodated in a can 120. The can 120 may include a body 120_1 having a receiving portion S formed therein, and a cover 120_2 coupled to the body 120_1 so as to seal the receiving portion S.

The electrode assembly 110 may be wound or stacked by placing a separator 116, which is an insulator, between a first electrode 112 corresponding to a positive electrode and a second electrode 114 corresponding to a negative electrode. The secondary battery 100 is not limited to the illustrated form and may be implemented in various other forms.

The positive electrode (e.g., first electrode 112) and the negative electrode (e.g., second electrode 114) may each include a current collector formed of a thin metal foil, a coated region with an active material, and an uncoated region where the active material is not coated. After placing the separator, which is an insulator, between the anode and cathode, the electrodes may be wound. However, the present disclosure is not limited thereto, and the aforementioned electrode assembly may also have a structure in which a plurality of sheet-type electrodes are alternately stacked with a separator interposed therebetween.

The positive electrode active material layer may include a positive electrode active material and may further include a binder and/or a conductive material(e.g., an electrically conductive material).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2(0.90≤a≤1.8, 0≤b≤0.9, 0≤c≤0.5, 0≤d≤0.5, and 0≤e≤0.1); LiaNiGbO2(0.90 ≤a≤1.8 and 0.001≤b≤0.1); LiaCoGbO2(0.90≤a≤1.8 and 0.001≤b≤0.1); LiaMn1-bGbO2 (0.90≤a≤1.8 and 0.001≤b≤0.1); LiaMn2GbO4(0.90≤a≤1.8 and 0.001≤b≤0.1); LiaMn 1-gGgPO4 (0.90≤a≤1.8 and 0≤g≤0.5); Li(3-f)Fe2(PO4)3 (0≤f≤2); or LiaFePO4(0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity(e.g., electrical conductivity) to the electrode. Any material that does not cause chemical change(e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

A negative electrode for a secondary battery may include a current collector and a negative electrode active material layer located on the current collector. The negative electrode active material layer may include a negative electrode active material and may further include a binder and/or a conductive material (e.g., an electrically conductive material).

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

The secondary battery 100 may further include a first substrate tab 132 formed on the first electrode 112 and a first electrode tab 142 connected to the first substrate tab 132. The first substrate tab 132 may be formed, for example, by stamping (punching) an uncoated portion of the first electrode 112. The first electrode tab 142 may be coupled to the first substrate tab 132 to be connected to the first electrode 112. The first electrode tab 142 and the first substrate tab 132 may be coupled by welding. The first electrode tab 142 may form a current flow path of the first electrode 112.

The secondary battery 100 may further include a second substrate tab 134 formed on the second electrode 114 and a second electrode tab 144 connected to the second substrate tab 134. The second substrate tab 134 may be formed, for example, by stamping (punching) an uncoated portion of the second electrode 114. The second electrode tab 144 may be coupled to the second substrate tab 134 to be connected to the second electrode 114. The second electrode tab 144 and the second substrate tab 134 may be coupled by welding. The second electrode tab 144 may form a current flow path of the second electrode 114.

In other embodiments, the first substrate tab 132 and the second substrate tab 134 may be omitted.

The can 120 forms the exterior of the secondary battery 100 and may be formed of a conductive metal, such as aluminum, an aluminum alloy, or steel plated with nickel. The can 120 may include a metallic material such as stainless use steel (SUS), aluminum (Al), and the like. However, these are merely examples, and the can 120 may be formed of various other metallic materials that provide required strength and resistance to external impact for the secondary battery 100.

The can 120 may further include a body 120_1 having an open receiving portion S for accommodating the electrode assembly 110. The receiving portion S of the body 120_1 may form an internal space that accommodates the electrode assembly 110 by pressing or the like. A planar shape of the receiving portion S of the can 120 may, for example, be substantially rectangular. The can 120 may further include a cover 120_2 welded to the body 120_1 to seal the open end of the receiving portion S. The cover 120_2 may be formed as a flat plate disposed on an upper portion of the can 120 to seal the receiving portion S. The cover 120_2 may be formed, for example, as a flat plate sized to cover the body 120_1 and may be in contact with the body 120_1. By coupling the body 120_1 and the cover 120_2, a single jointed structure may be formed. The body 120_1 may be coupled to the cover 120_2 by laser welding. However, in the present disclosure, the joining method is not limited, and various other coupling methods capable of sealing the can 120 may be used. For example, as an alternative to laser welding, the cover 120_2 and the body 120_1 may be joined by ultrasonic welding, brazing, laser brazing, welding, soldering, and so on. The body 120_1 and the cover 120_2 may be formed of the same metallic material. The metallic material may comprise, for example, at least one of aluminum, an aluminum alloy, and stainless steel.

Although not illustrated, the can 120 may further include an electrolyte injection port. The electrolyte injection port may be a through-hole formed on at least one side surface of the can 120, and may be formed to allow for an injection of an electrolyte into the can 120 after the body 120_1 and the cover 120_2 are coupled to seal the can 120. The electrolyte injection port may be sealed with a sealing member after the electrolyte is injected.

The secondary battery 100 may be a lithium battery cell or a sodium battery cell. However, the scope of the present disclosure is not limited to such types of batteries, and the secondary battery 100 encompasses all batteries that can repeatedly provide electric power through charging and discharging. In an embodiment where the secondary battery 100 is a lithium battery cell, the lithium battery cell may be used in electric vehicles (EVs) in view of its excellent lifespan characteristics and high-rate characteristics. For example, the lithium battery cell may be used in plug-in hybrid electric vehicles (PHEVs), and other hybrid vehicles. In addition, such lithium battery cells may be used in various other fields requiring a wide range of power storage, for example, smartphones, tablet PCs, electric bicycles, electric power tools, etc., without limitation.

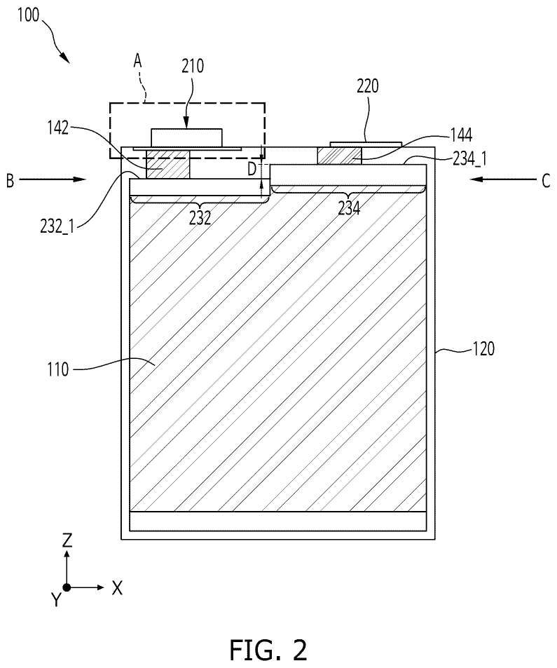

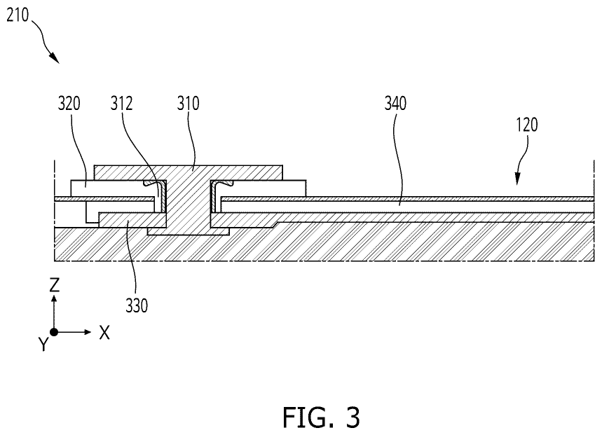

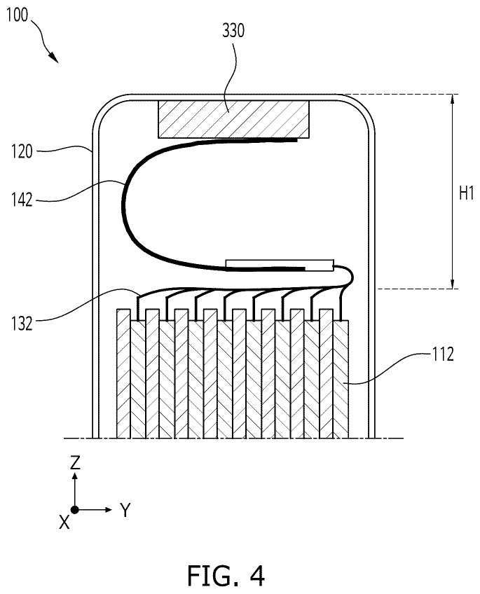

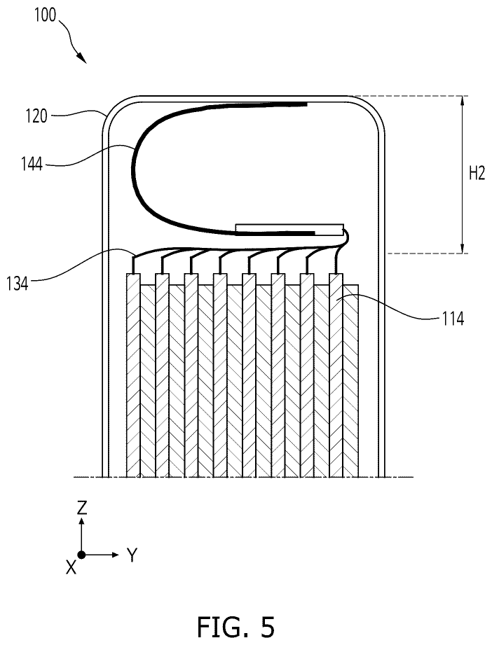

FIG. 2 is a cross-sectional view of the secondary battery 100 according to embodiments of the present disclosure. FIG. 3 is an enlarged view illustrating region A of FIG. 2. FIG. 4 is a cross-sectional view of the secondary battery 100 of FIG. 2, as viewed from direction B. FIG. 5 is a cross-sectional view of the secondary battery 100 of FIG. 2, as viewed from direction C. Referring to FIGS. 2 and 3, the electrode assembly 110 may have, at one end, a first horizontal portion 232 and a second horizontal portion 234, with there being a step difference D between the first horizontal portion 232 and the second horizontal portion. As such, the second horizontal portion 234 may be protrude in a direction perpendicular to the upper surface 232_1 of the first horizontal portion 232 such that the second horizontal portion 234 extends beyond the first horizontal portion 232. In the depicted example, the second horizontal portion 234 protrudes beyond the first horizontal portion 232 in a first direction Z. A first electrode tab 142 may be disposed/formed on the first horizontal portion 232, and a second electrode tab 144 may be disposed/formed on the second horizontal portion 234.

A first electrode terminal 210 may be further disposed on a surface of the can 120. The first electrode terminal 210 may be disposed over the first horizontal portion 232. The first electrode tab 142 may be connected to the first electrode terminal 210. In a specific example, the first electrode tab 142 may be a positive electrode tab, and the first electrode terminal 210 may be a positive electrode terminal. Accordingly, the positive electrode tab may be connected to the positive electrode terminal.

A second electrode terminal 220 may be further disposed on the surface of the can 120. The second electrode terminal 220 may be disposed over the second horizontal portion 234. The second electrode tab 144 may be connected to the second electrode terminal 220. However, in other embodiments, the second electrode terminal 220 may be omitted. The second electrode tab 144 may be connected to the can 120. For example, the second electrode tab 144 may be welded to the can 120. In a specific example, the second electrode tab 144 may be a negative electrode tab. And a length of the first electrode tab 142 may be greater than a length of the second electrode tab 144.

Referring to FIGS. 2 and 3, the first electrode terminal 210 may include a terminal portion 310, a gasket 320, a terminal plate 330, and an insulating plate 340. The terminal portion 310 may be inserted into a through-hole 312 formed in the surface of the can 120. The terminal portion 310 may be formed of copper, aluminum, an alloy of copper, or other various conductive metal materials without limitation. The gasket 320 is inserted into the through-hole 312 to insulate the terminal portion 310 from the can 120. The gasket 320 may be formed of an insulating material. The terminal plate 330 may be connected to the terminal portion 310 inside the can 120. The terminal plate 330 may be formed of the same material as the terminal portion 310. The terminal plate 330 may be formed, for example, of copper, aluminum, an alloy of copper, or other various conductive metal materials without limitation. The insulating plate 340 is disposed between the can 120 and the terminal plate 330 and insulates the terminal plate 330 from the can 120.

The first electrode tab 142 may be connected to the terminal portion 310, or the first electrode tab 142 may be connected to the terminal plate 330. The second horizontal portion 234 may not be in contact with the terminal plate 330. In other words, the second horizontal portion 234 may not be electrically connected to the terminal plate 330. In the depicted example, the second horizontal portion 234 may extend in a direction parallel to the upper surface 234_1 of the second horizontal portion 234. Here, the second horizontal portion 234 may extend only to an extent that it does not contact the terminal plate 330. Thus, it is possible to prevent the second horizontal portion 234 from contacting the terminal plate 330.

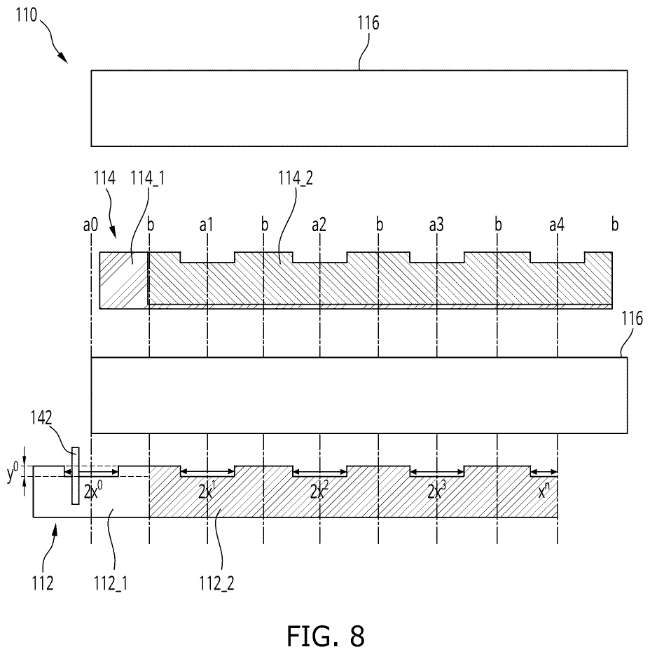

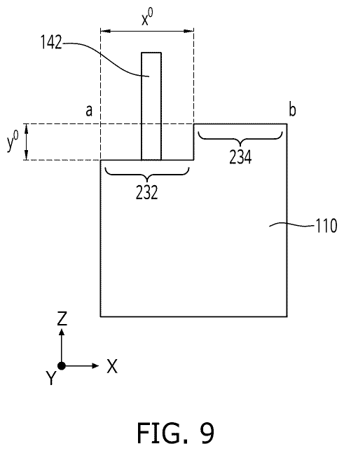

Referring again to FIG. 1, the separator 116 of the electrode assembly 110 may be formed to protrude more in a direction perpendicular to the upper surfaces 232_1 of the first horizontal portion 232 and 234_1 of the second horizontal portion 234 and beyond the first electrode 112 and the second electrode 114. That is, the separator 116 may be formed to protrude further in a first direction (e.g., direction (Z)) than the first electrode 112 and the second electrode 114. By cutting the separator 116 to at least at a height corresponding to the step difference D (for example, a length of twice D) in a direction perpendicular to the upper surface 232_1 of the first horizontal portion 232 at the boundary between the first horizontal portion 232 and the second horizontal portion 234, the first horizontal portion 232 and the second horizontal portion 234 may be formed. As will be described later with reference to FIGS. 8 and 9, a separate forming process may be performed to provide a step difference to the separator 116 when the first electrode 112 and the second electrode 114 are formed to have a predetermined step difference. Accordingly, in the separator 116, a cut portion may be formed at the boundary between the first horizontal portion 232 and the second horizontal portion 234, at least up to the step difference D in the direction perpendicular to the upper surface 232_1 of the first horizontal portion 232. For example, after forming a cut portion of length at least D, the separator 116 may be trimmed or cut by an amount corresponding to the first horizontal portion 232, thereby forming the separator 116 so as to have the step difference D. Or, after forming a cutting portion of length at least D, the separator 116 may be folded by an amount corresponding to the first horizontal portion 232 so that the separator 116 has the step difference D.

Referring again to FIGS. 2 and 4, the first electrode 112 may be formed as a plurality of electrodes inside the can 120. Uncoated portions of the first electrodes 112 may be bent to form a first substrate tab 132. The first electrode tab 142 may be connected to the first substrate tab 132. For example, the first substrate tab 132 and the first electrode tab 142 may be coupled by welding or the like. The first electrode tab 142 may be bent in a space between the first horizontal portion 232 and the first electrode terminal 210. The bent first electrode tab 142 may be connected to the terminal plate 330 of the first electrode terminal 210. For example, the first electrode tab 142 may be coupled (e.g., welded) to the terminal plate 330. A height H1 of the space formed between the first horizontal portion 232 and the first electrode terminal 210 may be the height of a remaining empty space of the can 120 on the first horizontal portion 232 after the electrode assembly 110 is disposed.

Referring to FIGS. 2 and 5, the second electrode 114 may be formed as a plurality of electrodes inside the can 120. Uncoated portions of the second electrodes 114 may be bent to form a second substrate tab 134. The second electrode tab 144 may be connected to the second substrate tab 134. For example, the second substrate tab 134 and the second electrode tab 144 may be coupled by welding or the like. The second electrode tab 144 may be bent in a space between the second horizontal portion 234 and the can 120. The bent second electrode tab 144 may be connected to the can 120. For example, the second electrode tab 144 may be coupled (e.g., welded) to the can 120. A height H2 of the space formed between the second horizontal portion 234 and the can 120 may be the height of a remaining empty space of the can 120 on the second horizontal portion 234 after the electrode assembly 110 is disposed. The height H2 of the space formed between the second horizontal portion 234 and the can 120 may be less than the height (e.g., H1 in FIG. 4) of the space formed between the first horizontal portion 232 and the first electrode terminal 210.

By forming an end of the electrode assembly to have a step difference as described above, it is possible to dispose the electrode assembly in a remaining empty space inside the can. Accordingly, a secondary battery with improved energy density may be provided.

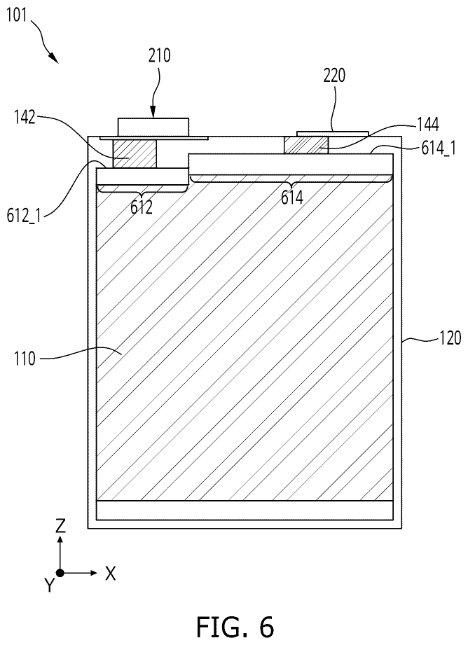

FIG. 6 is a cross-sectional view of a secondary battery 101 according to embodiments of the present disclosure. Referring to FIG. 6, the electrode assembly 110 may have, at one end, a first horizontal portion 612 and a second horizontal portion 614, with there being a step difference between the first horizontal portion 612 and the second horizontal portion 614. Here, the second horizontal portion 614 may protrude in a direction perpendicular to the upper surface 612_1 of the first horizontal portion 612 beyond the first horizontal portion 612. For example, the second horizontal portion 614 may be formed to protrude beyond the first horizontal portion 612 in a first direction (Z. A first electrode tab 142 may be disposed on the first horizontal portion 612, and a second electrode tab 144 may be disposed on the second horizontal portion 614. A length of the second horizontal portion 614 in a direction parallel to the upper surface 614_1 thereof may be greater than a length of the first horizontal portion 612 in a direction parallel to the upper surface 612_1 thereof. The second horizontal portion 614 may extend in a direction parallel to its upper surface 614_1, but the second horizontal portion 614 may be spaced from the first electrode terminal 210 such that the second horizontal portion 614 does not contact the first electrode terminal 210 in the Z direction. Thus, the second horizontal portion 614 may not be electrically connected to the first electrode terminal 210.

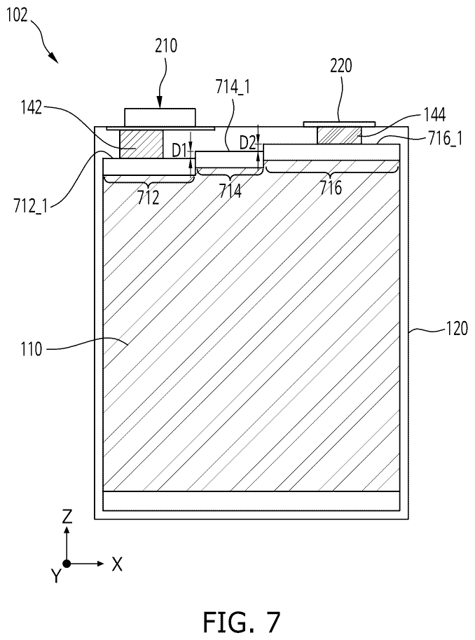

FIG. 7 is a cross-sectional view illustrating a secondary battery 102 according to embodiments of the present disclosure. Referring to FIG. 7, the electrode assembly 110 may have, at one end, a first horizontal portion 612 and a second horizontal portion 714, with there being a first step difference D1 between the first horizontal portion 712 and the second horizontal portion 714. The second horizontal portion 714 may protrude in a direction perpendicular to the upper surface 712_1 of the first horizontal portion 712 beyond the first horizontal portion 712. That is, the second horizontal portion 714 may protrude beyond the first horizontal portion 712 in a first direction Z. A first electrode tab 142 may be disposed on the first horizontal portion 712. A length of the second horizontal portion 714 in a direction parallel to its upper surface 714_1 may be equal to the length of the first horizontal portion 712 in a direction parallel to its upper surface 712_1. However, in other embodiments, the first horizontal portion 712 and the second horizontal portion 714 may have different lengths. The second horizontal portion 714 may not be in contact the first electrode terminal 210 in the Z direction. Thus, the second horizontal portion 714 may not be electrically connected to the first electrode terminal 210.

A third horizontal portion 716 may be formed at one end of the electrode assembly 110, with there being a second step difference D2 between the second horizontal portion 714 and the third horizontal portion 716. The third horizontal portion 716 may be formed to protrude in a direction perpendicular to the upper surface 712_1 of the first horizontal portion 712 beyond both the first horizontal portion 712 and the second horizontal portion 714. For example, the third horizontal portion 716 may protrude beyond the first horizontal portion 712 and the second horizontal portion 714 in a first direction Z. A second electrode tab 144 may be disposed on the third horizontal portion 716. In this configuration, the second horizontal portion 714 may be formed between the first horizontal portion 712 and the third horizontal portion 716. A length of the third horizontal portion 716 in a direction parallel to its upper surface 716_1 may be greater than a length of the first horizontal portion 712 in a direction parallel to its upper surface 712_1. And a length of the third horizontal portion 716 in a direction parallel to its upper surface 716_1 may also be greater than a length of the second horizontal portion 714 in a direction parallel to its upper surface 714_1. However, the third horizontal portion 716 may not be in contact with the first electrode terminal 210 in the X direction such that the third horizontal portion 716 is not electrically connected to the first electrode terminal 210.

FIG. 8 is a diagram illustrating a method of manufacturing the electrode assembly 110 according to embodiments of the present disclosure. FIG. 9 illustrates the electrode assembly 110 assembled by the manufacturing method of FIG. 8. Referring to FIGS. 8 and 9, the electrode assembly 110 may include a first electrode 112 that has a first coating portion 112_2 formed by coating an active material layer on a substrate and a first uncoated portion 112_1 where the active material layer is not provided. The electrode assembly 110 may also include a second electrode 114 that has a second coating portion 114_1 formed by coating an active material layer on a substrate and a second uncoated portion 114_2 where the active material layer is not provided. In order to form a step, a portion of the first electrode 112 and the second electrode 114 may be notched. And by forming the step, the first horizontal portion 232 and the second horizontal portion 234 may be formed. For instance, a step y0 may be formed between the first horizontal portion 232 and the second horizontal portion 234. A horizontal length (x0) of the first horizontal portion 232 (e.g., in an X direction) may be less than a horizontal length of the second horizontal portion 234 (e.g., in the X direction). However, the horizontal lengths of the first horizontal portion 232 and the second horizontal portion 234 may be the same in other embodiments.

Next, the first electrode tab 142 may be coupled to the first uncoated portion 112_1 of the first electrode 112. Then the electrode assembly 110 may be made by winding or stacking the first electrode 112 and the second electrode 114 with the separator 116 interposed therebetween. After the electrode assembly 110 has been made, the separator 116 may be cut at the boundary between the first horizontal portion 232 and the second horizontal portion 234 in a first direction (e.g., direction (Z)) by an amount at least equal to the step y0 (for example, twice y0, or the step D in FIG. 2). Accordingly, a cut portion may be formed in the separator 116. After forming the cut portion of at least y0, the separator 116 may be trimmed or cut by an amount corresponding to the first horizontal portion 232, thereby forming the separator 116 with a step difference (for example, D in FIG. 2). In another embodiment, after forming a cutting portion of at least y0, the separator 116 may be folded by an amount corresponding to the first horizontal portion 232 so that the separator 116 has the step difference (for example, D in FIG. 2). The first electrode tab 142 may be disposed on the first horizontal portion 232 by winding or stacking the first electrode 112 and the second electrode 114 such that the first electrode tab 142 is positioned thereon.

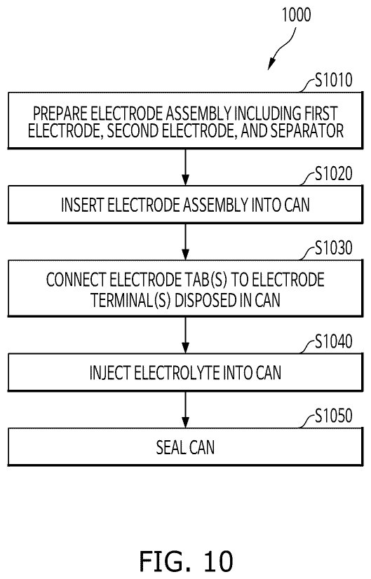

FIG. 10 is a flowchart of a method of manufacturing a secondary battery 1000 according to embodiments of the present disclosure.

Referring to FIG. 10, the method of manufacturing the secondary battery 1000 may begin with a step S1010 of preparing an electrode assembly that includes a first electrode, a second electrode, and a separator. Then, in step S1020, the electrode assembly may be inserted into a can.

For example, referring to FIGS. 1 and 2, the can 120 may be a hexahedral case. The can 120 forms the exterior of the secondary battery 100 and may be formed of a conductive metal, such as aluminum, an aluminum alloy, or steel plated with nickel. The can 120 may include a metallic material such as stainless steel (SUS), aluminum (Al), and the like. However, these are merely examples, and the can 120 may be formed of various other metallic materials that provide required strength and resistance to external impact for the secondary battery 100.

The can 120 may include a body 120_1 having a receiving portion S formed with an open end to allow for the insertion of the electrode assembly 110. The receiving portion S of the body 120_1 may be configured to form an internal space in which the electrode assembly 110 is accommodated by pressing or the like. A planar shape of the receiving portion S of the can 120 may, for example, be substantially rectangular. The can 120 may further include a cover 120_2 welded to the body 120_1 to seal the open end of the receiving portion S. The cover 120_2 may be formed as a flat plate disposed on an upper portion of the can 120 to seal the receiving portion S. For example, the cover 120_2 may be formed as a flat plate sized to cover the body 120_1 and may be in contact with the body 120_1. By coupling the body 120_1 and the cover 120_2, a single jointed structure may be formed.

The electrode assembly 110 may have at one end a first horizontal portion 232 and a second horizontal portion 234, with a step difference D being formed between the first horizontal portion 232 and the second horizontal portion 234. The second horizontal portion 234 may be protrude in a direction perpendicular to the upper surface 232_1 of the first horizontal portion 232 beyond the first horizontal portion 232. For example, the second horizontal portion 234 may be formed to protrude beyond the first horizontal portion 232 in a first direction Z. A first electrode tab 142 may be disposed on the first horizontal portion 232, and a second electrode tab 144 may be disposed on the second horizontal portion 234.

In step S1030 the electrode tabs may be coupled to electrode terminals disposed on the can. For example, referring to FIG. 2, a first electrode terminal 210 may be disposed on a surface of the can 120. The first electrode terminal 210 may be disposed on the first horizontal portion 232. The first electrode tab 142 may be connected to the first electrode terminal 210. In a specific example, the first electrode tab 142 may be a positive electrode tab, and the first electrode terminal 210 may be a positive electrode terminal. Accordingly, the positive electrode tab may be connected to the positive electrode terminal.

A second electrode terminal 220 may be disposed on the surface of the can 120. The second electrode terminal 220 may be disposed over the second horizontal portion 234. The second electrode tab 144 may be connected to the second electrode terminal 220. However, in other embodiments, the second electrode terminal 220 may be omitted. The second electrode tab 144 may be connected to the can 120. For example, the second electrode tab 144 may be welded to the can 120. In a specific example, the second electrode tab 144 may be a negative electrode tab. A length of the first electrode tab 142 may be greater than a length of the second electrode tab 144.

In step S1040 an electrolyte may be injected into the can 120 through an electrolyte injection port. The electrolyte injection port may be a through-hole formed on at least one side surface of the can 120, and may be formed to allow the electrolyte to be injected into the can 120 after the body 120_1 and the cover 120_2 are coupled to seal the can 120. After the electrolyte is injected, the electrolyte injection port may be sealed by a sealing member.

Finally, in step S1050, by sealing the can, the secondary battery is made. In another embodiment, after sealing the can, the electrolyte may be injected into the can.

As described above, by forming an end of the electrode assembly to have a step difference, it is possible to dispose the electrode assembly in a remaining empty space inside the can. Accordingly, a secondary battery with improved energy density may be provided. In addition, by using a can formed of a metal as the exterior material of the secondary battery, it is possible to facilitate detaching the secondary battery.

The flowchart of FIG. 10 and the above description are merely an embodiment of the present disclosure, and the scope of the present disclosure is not limited to the flowchart of FIG. 10 and the above description. For example, one or more steps of the flowchart and the above description may be added/changed/deleted, the order of one or more steps may be changed, or one or more steps may be performed simultaneously.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF SOME REFERENCE SYMBOLS

100: secondary battery
110: electrode assembly
112: first electrode
114: second electrode
116: separator
120: can
120_1: body
S: receiving portion
120_2: cover
132: first substrate tab
134: second substrate tab
142: first electrode tab
144: second electrode tab

What is claimed is:

1. A secondary battery comprising:
a can;
an electrode assembly accommodated in the can, the electrode assembly comprising a first electrode, a second electrode, and a separator disposed between the first electrode and the second electrode, the electrode assembly further comprising a first horizontal portion and a second horizontal portion at an end of the electrode assembly, with a step being formed between the first horizontal portion and the second horizontal portion;
a first electrode tab connected to the first electrode; and
a second electrode tab connected to the second electrode.

2. The secondary battery according to claim 1, wherein the second horizontal portion protrudes beyond the first horizontal portion in a direction perpendicular to an upper surface of the first horizontal portion.

3. The secondary battery according to claim 1, wherein a part of the first electrode tab is disposed on the first horizontal portion, and a part of the second electrode tab is disposed on the second horizontal portion.

4. The secondary battery according to claim 1, further comprising:
an electrode terminal disposed on a surface of the can,
wherein the first electrode tab is connected to the electrode terminal, and
wherein the second electrode tab is connected to the can.

5. The secondary battery according to claim 4, wherein the first electrode tab is bent in a space between the first horizontal portion and the first electrode terminal, and
wherein the second electrode tab is bent in a space between the second horizontal portion and the can.

6. The secondary battery according to claim 4, wherein the first electrode terminal comprises:
a terminal portion extending through a hole formed in the can;
a gasket inserted into the hole to insulate between the terminal portion and the can;
a terminal plate connected to the terminal portion inside the can; and
an insulating plate disposed between the can and the terminal plate to insulate between the terminal plate and the can.

7. The secondary battery according to claim 6, wherein the first electrode tab is connected to the terminal plate.

8. The secondary battery according to claim 6, wherein the second horizontal portion does not contact the terminal plate.

9. The secondary battery according to claim 1, wherein a length of the second horizontal portion in a direction parallel to an upper surface of the second horizontal portion is greater than a length of the first horizontal portion in a direction parallel to an upper surface of the first horizontal portion.

10. The secondary battery according to claim 1, wherein the can comprises a metallic material, and the metallic material comprises at least one of aluminum, aluminum alloy, and stainless steel.

11. The secondary battery according to claim 1, wherein the first electrode tab is longer than the second electrode tab.

12. A secondary battery comprising:
a can;
an electrode assembly accommodated in the can, the electrode assembly comprising a first electrode, a second electrode, and a separator disposed between the first electrode and the second electrode, the electrode assembly further comprising a first horizontal portion a second horizontal portion, and a third horizontal portion at an end of the electrode assembly, with a first step being formed between the first horizontal portion and the second horizontal portion, and with a second step being formed between the second horizontal portion and the third horizontal portion;
a first electrode tab connected to the first electrode; and
a second electrode tab connected to the second electrode.

13. The secondary battery according to claim 12, wherein the second horizontal portion is between the first horizontal portion and the third horizontal portion.

14. The secondary battery according to claim 12, wherein the second horizontal portion protrudes beyond the first horizontal portion in a direction perpendicular to an upper surface of the first horizontal portion, and
wherein the third horizontal portion protrudes beyond the second horizontal portion in a direction perpendicular to the upper surface of the first horizontal portion.

15. The secondary battery according to claim 12, wherein a part of the first electrode tab is disposed on the first horizontal portion, and a part of the second electrode tab is disposed on the third horizontal portion.

16. The secondary battery according to claim 12, further comprising:
an electrode terminal disposed on a surface of the can,
wherein the first electrode tab is connected to the electrode terminal, and
wherein the second electrode tab is connected to the can.

17. The secondary battery according to claim 16, wherein the first electrode terminal comprises:
a terminal portion extending through a hole formed in the can;
a gasket inserted into the hole and to insulate between the terminal portion and the can;
a terminal plate connected to the terminal portion inside the can; and
an insulating plate disposed between the can and the terminal plate to insulate between the terminal plate and the can.

18. The secondary battery according to claim 17, wherein the first electrode tab is connected to the terminal plate.

19. The secondary battery according to claim 17, wherein the second horizontal portion and the third horizontal portion do not contact the terminal plate.

20. The secondary battery according to claim 11, wherein the first electrode tab is longer than the second electrode tab.
